(19) United States
(12) Patent Application Publication
(10) Pub. No.: US 2019/0355356 A1
(43) Pub. Date: Nov. 21, 2019

(54) INFORMATION PROCESSING DEVICE AND NON-TRANSITORY COMPUTER READABLE MEDIUM STORING PROGRAM

(71) Applicant: FUJI XEROX CO., LTD., Tokyo (JP)

(72) Inventors: Kengo TOKUCHI, Kanagawa (JP); Tadahiro OISHI, Kanagawa (JP); Ayaka SATO, Kanagawa (JP)

(73) Assignee: FUJI XEROX CO., LTD., Tokyo (JP)

(21) Appl. No.: 16/404,819

(22) Filed: May 7, 2019

(30) Foreign Application Priority Data
May 21, 2018 (JP) 2018-097347

(51) Int. Cl. G10L 15/22; H04L 12/58

(52) U.S. Cl. CPC G10L 15/22; H04L 51/02; G10L 2015/225; G10L 2015/228; G10L 2015/223

(57) ABSTRACT

An information processing device includes: a control unit that, when a request for change of setting is made by a user through a conversational user interface, controls notification of setting information of a program portion to which the change of setting is to be made; and a change unit that changes the program portion in accordance with the request for the change of setting.

### CROSS-REFERENCE TO RELATED APPLICATIONS

This application is based on and claims priority under 35 USC 119 from Japanese Patent Application No. 2018-097347 filed May 21, 2018.

### BACKGROUND

### (i) Technical Field

The present disclosure relates to an information processing device and a non-transitory computer readable medium storing a program.

### (ii) Related Art

Japanese Unexamined Patent Application Publication No. 2006-68489 describes a program in which a procedure for exchanging conversation with a user is defined with branching conditions. In the program, the contents of a question, multiple selections each as an answer to the question, and an action for each selection are associated with each other.

### SUMMARY

Aspects of non-limiting embodiments of the present disclosure relate to a technique for editing a program utilizing a conversational user interface.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing device including: a control unit that, when a request for change of setting is made by a user through a conversational user interface, controls notification of setting information of a program portion to which the change of setting is to be made; and a change unit that changes the program portion in accordance with the request for the change of setting.

### BRIEF DESCRIPTION OF THE DRAWINGS

Exemplary embodiments of the present disclosure will be described in detail based on the following figures, wherein:

FIG. 1 is a block diagram illustrating the configuration of an information processing system according to an exemplary embodiment of the disclosure.

FIG. 2 is a block diagram illustrating the configuration of a terminal apparatus;

FIG. 3 is a block diagram illustrating the configuration of a device;

FIG. 4 is a view illustrating the appearance of a robot;

FIG. 5 is a view illustrating the appearance of a speaker device;

FIG. 6 is a view illustrating a screen;

FIG. 7 is a view illustrating a screen;

FIG. 8 is a view illustrating a screen;

FIG. 9 is a view illustrating a screen;

FIG. 10 is a view illustrating a screen;

FIG. 11 is a view illustrating a screen;

FIG. 12 is a view illustrating a screen;

FIG. 13 is a view illustrating a screen;

FIG. 14 is a view illustrating a screen;

FIG. 15 is a view illustrating part of a screen;

FIGS. 16A and 16B are each a view illustrating an image associated with a device; and

FIG. 17 is a view illustrating a screen.

### DETAILED DESCRIPTION

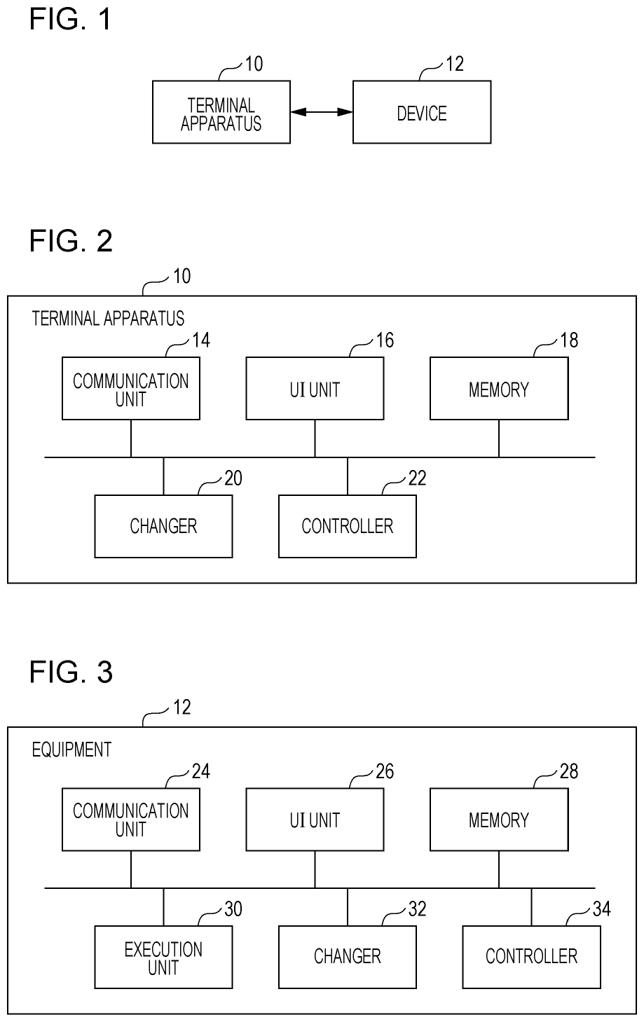

An information processing system according to an exemplary embodiment of the present disclosure will be described with reference to FIG. 1. FIG. 1 illustrates an example of an information processing system according to the exemplary embodiment.

The information processing system according to the exemplary embodiment includes a terminal apparatus 10 and one or multiple pieces of a device 12.

The terminal apparatus 10 is a device such as PC, a tablet PC, a smartphone, or a mobile phone. The terminal apparatus 10 may be a wearable terminal (such as a watch terminal, a wristband terminal, an eyeglass terminal, a ring terminal, a contact lens terminal, a body embedded terminal, and a bearable terminal). Alternatively, the terminal apparatus 10 may have a flexible display as a display device. For instance, an organic electroluminescence display (flexible organic EL display), an electronic paper display, or a flexible liquid crystal display is used as a display device. A flexible display, which uses a display system other than these, may be used. A flexible display is a display having a deformable display section, and allows, for instance, bending, folding, winding, twisting, or stretching. The entire terminal apparatus may be configurated by a flexible display, and a flexible display and components other than the flexible display may be functionally or physically separated from each

A device 12 is a device having a function, for instance, an image forming device having an image forming function (such as a scan function, a print function, a copy function, a facsimile function), a personal computer (PC), a tablet PC, a smartphone, a mobile phone, a robot (such as a humanoid robot, an animal robot other than the humanoid human, robots other than these robots), a projector, a display device such as a liquid crystal display, a recording device, a reproduction device, an imaging device such as a camera, a refrigerator, a rice cooker, a microwave oven, a coffee brewer, a cleaner, a washing machine, an air conditioner, a lighting device, a clock, a monitoring camera, an automobile, a two-wheeled vehicle, an airplane (for instance, an unmanned aerial vehicle (so-called drone)), a game machine, and various sensing devices (for instance, a temperature sensor, a humidity sensor, a voltage sensor, and a current sensor). The device 12 may be a device (for instance, an image forming apparatus, or a PC) which outputs information to a user, or a device (for instance, a sensing device) which does not output information to a user. The category of the concept of device 12 may include general equipment, and also may include, for instance, information equipment, video equipment, audio equipment, and other equipment. In addition, the category of the concept of device 12 may include a server which provides various functions, and a server which provides various services.

In addition, the terminal apparatus 10 and the device 12 have a function of communicating with other devices. The communication may be wireless communication or wired communication. For instance, the terminal apparatus 10 and the device 12 may communicate with other devices via a communication line such as the Internet, directly, via a repeater which functions as a hub, or via so-called cloud or server. The device 12 may be so-called Internet of Things (IoT) equipment.

In the terminal apparatus 10, a conversation partner having a function of interacting with a user is used. The conversation partner is a personal assistant (operation assistant) which replies to inquiries from a user. The personal assistant, for instance, receives an utterance of a user, generates a reply such as an answer to the speech by analyzing the content of an utterance, and notifies the user of the reply. For instance, speech of a user is performed by character input, voice input, or image input, and reply is performed by character output, voice output, or image output. A combination of multiple types of inputs may be used, and a combination of multiple types of outputs may be used. The personal assistant analyzes the content of the speech of a user by applying, for instance, natural language processing such as a morphological analysis to inputted information. The personal assistant is implemented by executing a program, for instance. A program for performing the personal assistant is installed, for instance, in the terminal apparatus 10. It goes without saying that the program is installed in the device 12, The function of the personal assistant or a service that provides the function may be provided to the terminal apparatus 10 from the device 12. As another example, the program may be installed in an apparatus such as a server, and the function of the personal assistant or a service that provides the function may be provided to the terminal apparatus 10 from the server.

The personal assistant is configurated by, for instance, by auto reply artificial intelligence implemented by artificial intelligence (A.I.). The auto reply AI has functions of analyzing the content of speech of a user, and notifying the user of a reply such as an answer to the content of speech. The auto reply AI may be a so-called chatbot (automatic conversation program utilizing artificial intelligence). The auto reply AI may have a learning function using artificial intelligence, and may have ability to make decision almost like a human by the learning function. Alternatively, a neural network deep learning may be utilized, enrichment learning, in which particular learning field is enriched, may be utilized, and in addition, a genetic algorithm, a cluster analysis, a self-organization map, and ensemble learning may be utilized. It goes without saying that a technique related to artificial intelligence other than those may be utilized. The auto reply AI may search for an answer to inquiries from a user by utilizing a network such as the Internet, generate a reply based on results of the search, and notifies the user of the reply.

A personal assistant may operate in accordance with instructions from a user associated with a user account which has logged in the personal assistant. Even the same personal assistant may reply according to a user account which has logged in the personal assistant. Multiple user accounts may log in the same personal assistant.

Also, the personal assistant mounted in the terminal apparatus 10 may control hardware configuring the terminal apparatus 10 or software installed in the terminal apparatus 10. Also, the personal assistant may control the device 12 connected to the terminal apparatus 10.

A personal assistant for assisting a user may be mounted in the device 12. A personal assistant may control hardware included in the device 12 in which the personal assistant is mounted, or may control software installed in the device 12. Alternatively, a personal assistant may control another device 12 connected to the device 12 in which the personal assistant is mounted. Similarly to a personal assistant mounted in the terminal apparatus 10, a personal assistant mounted in the device 12 may analyze the content of speech of a user, and may notify the user of a reply to the content of speech. It is to be noted that a personal assistant mounted in the terminal apparatus 10 and a personal assistant mounted in the device 12 may be the same type of personal assistant or different types of personal assistant.

In the exemplary embodiment, a technique for editing a program is provided. For instance, a conversational user interface is provided in the terminal apparatus 10. The user interface is for exchanging messages between a user and a conversation partner (for instance, a personal assistant). A personal assistant as a conversation partner of a user may be a personal assistant mounted in the terminal apparatus 10, or a personal assistant mounted in the device 12. A request for change of setting at a program portion (program section) is made by a user through the user interface. In this case, a user is notified of current setting information at a program portion to which the change of setting is to be made, and the program portion is changed in accordance with the request for change of setting. In this manner, the program is edited via the conversational user interface. The category of the concept of edition of program includes partial change of program, addition of processing to program, partial deletion from program, change of entire program, and deletion of entire program. In addition, the category of the concept of edition of program may include creation of a new program in addition to rewriting of an existing program. Also, a conversational user interface may be provided in the device 12, and a request for change of setting at a program portion may be made by a user via the user interface.

It is to be noted that a program portion to which the change of setting is to be made may be a program stored in the terminal apparatus 10, a program stored in the device 12, a program executed by the terminal apparatus 10, a program executed by the device 12, a program for controlling the terminal apparatus 10, or a program for controlling the device 12.

For instance, notification and change of setting of a program portion stored in the terminal apparatus 10 may be made by exchanging messages between the personal assistant mounted in the terminal apparatus 10 and a user. Alternatively, notification and change of setting of a program portion stored in the device 12 may be made by exchanging messages between the personal assistant mounted in the device 12 and a user. It goes without saying that the exemplary embodiment is not limited to those combinations. Notification and change of setting of a program portion stored in the device 12 connected to the terminal apparatus 10 may be made by exchanging messages between the personal assistant mounted in the terminal apparatus 10 and a user. The same goes with a program stored in the terminal apparatus 10. Alternatively, notification and change of setting of a program portion stored in the terminal apparatus 10 or the device 12 may be made by exchanging messages between the personal assistant mounted in an external apparatus such as a server and a user.

It is to be noted that the device 12 does not need to be included in the information processing system according to the exemplary embodiment. For instance, in order to make notification and change of setting of a program portion stored in the device 12, the terminal apparatus 10 may be connected to the device 12, and thereby an information processing system may be constructed. When notification and change of setting of a program portion stored in the terminal apparatus 10 is made and notification and change of setting of a program portion stored in the device 12 is not made, the device 12 does not need to be included in the information processing system.

Hereinafter, the configuration of the terminal apparatus 10 will be described with reference to FIG. 2. FIG. 2 illustrates an example of the configuration of the terminal apparatus 10.

A communication unit 14 is a communication interface, and has functions of transmitting data to other devices and receiving data from other devices. The communication unit 14 may be a communication interface having a wireless communication function, or a communication interface having a wired communication function. The communication unit 14 supports, for instance one or multiple types of communication system, and may communicate with a communication partner in accordance with a communication system suitable for the communication partner (in other words, a communication system supported by the communication partner). The communication system includes, for instance, infrared ray communication, visible light communication, Wi-Fi (registered trademark) communication, and proximity wireless communication (for instance, Near Field Communication (NFC)). As the proximity wireless communication, Felica (registered trademark), Bluetooth (registered trademark), or Radio Frequency Identifier (RFID) is used. Also, the communication unit 14 may support the 5th generation mobile communication system (5G). It goes without saying that another wireless communication system may be used as the proximity wireless communication. The communication unit 14 may change a communication system and/or a frequency band according to a communication partner or according to the surrounding environment. For instance, 2.4 GHz or 5 GHz may be used as the frequency band.

An UI unit 16 is a user interface unit, and includes a display and an operation unit. The display is a display device such as a liquid crystal display. The display may be a flexible display. The operation unit is an input device such as a touch panel or a keyboard. The UI unit 16 may be a user interface (including, for instance, a touch display, and a device which electronically displays a keyboard on a display) serving as both a display and an operation unit. Also, the UI unit 16 may include a sound collector such as a microphone and a sound generator such as a speaker. In this case, information may be inputted to the device 12 by voice input, and information may be outputted by voice.

A storage 18 is a storage device such as a hard disk or a memory (for instance, SSD). In the storage 18, for instance, various types of data and various types of programs are stored. As the program, for instance, an operating system (OS), various application programs, an automatic conversation program for implementing a chatbot, and a personal assistant program are stored. It is to be noted that when the personal assistant has the function of chatbot, the personal assistant program includes an automatic conversation program. Also, the storage 18 may store device address information (for instance, an IP address or a MAC Address) indicating the address of device 12, and server address information (for instance, an IP address or a MAC Address) indicating the address of a server. A program to which notification and change of setting are to be made may be stored in the storage 18. Each program is associated with program identification information for identifying the program. The program identification information is, for instance, the name or ID of a program.

A changer 20 is configurated to change a program portion. The changer 20 may automatically change a program portion in accordance with a request for change of setting. As another example, a candidate group for processing (commands, functions) corresponding to the content of change of setting may be provided to a user, and the changer 20 may reflect processing (command, function) selected from the candidate group by a user in the program portion. As still another example, the changer 20 may generate a candidate group for program portion in which change in accordance with a request for change of setting has been reflected. In this case, the candidate group is provided to a user, and the changer 20 identifies a candidate as a post-change program portion, the candidate being selected from the candidate group by the user.

A controller 22 is configurated to control the operation of each component of the terminal apparatus 10. For instance, the controller 22 performs execution of a program, control of communication performed by the communication unit 14, control of notification (for instance, display and voice output of information) of information using the UI unit 16, receiving of information inputted to the terminal apparatus 10 using the UI unit 16, writing of information to the storage 18, and reading of information from the storage 18.

In addition, the controller 22 is configurated to control notification of the current setting information of a program portion to which the change of setting is to be made. The controller 22 may display on the display of the UI unit 16 a character string showing the setting information of the program portion or a graphic showing the setting information of the program portion.

Here, the meaning of each of terms is defined. Program location is, for instance, a set including one or multiple pieces of unit processing (unit command, unit function), and is information in which one or multiple pieces of unit processing are described.

Character string showing a program portion is a character string in which the program portion is written by a programming language, for instance is a source code. For instance, a compiler language or a script language may be used as a program language. For instance, C language, C++, Java (registered trademark), or C# is used as a compiler language. For instance, Python, Perl, PHP, Ruby, or JavaScript (registered trademark) is used as a script language.

Block diagram showing a program portion is a diagram that shows the processing executed by the program portion. For instance, unit processing (unit command, unit function) is defined in advance, and each unit processing is associated with a graphic. In short, each unit processing is shown by a graphic. Block diagram is a diagram that shows one or multiple pieces of unit processing, and is configurated by one or multiple graphics. For instance, a node in Node-Red corresponds to an example of the graphic. Also, one or multiple pieces of unit processing are packaged, and the packaged processing may be represented by one graphic (for instance, one node). In other words, one graphic may be a graphic that shows one unit processing or a packaged multiple pieces of unit processing. A packaged graphics may be created by a user.

A source code and a graphic may be mutually convertible. For instance, when certain processing is represented as a character string in accordance with the representative form of source code, the character string may be converted to a graphic which represents the processing. Similarly, when certain processing is represented in accordance with the representative form of graphic, a graphic representing the processing may be converted to a character string which is the representative form of source code. For instance, for each processing, a character string (a character string represented in accordance with the representative form of source code) indicating processing (command, function), and a graphic (a graphic represented in accordance with the representative form of block diagram) showing the processing are associated with each other, and information indicating the association is prepared in advance. The information indicating the association may be stored in the terminal apparatus 10, the device 12, or an apparatus such as a server. Referring to the information allows a character string and a graphic represented in the representative form of source code to be mutually converted. It is to be noted that every one or multiple pieces of unit processing, the above-mentioned association may be managed.

Hereinafter, the configuration of the device 12 will be described with reference to FIG. 3. FIG. 3 illustrates an example of the configuration of the device 12. FIG. 3 illustrates the configuration which is shared in common by all devices 12, and does not illustrate a specific configuration of each device 12.

A communication unit 24 is a communication interface, and has functions of transmitting data to other devices and receiving data from other devices. The communication unit 24 may be a communication interface having a wireless communication function, or a communication interface having a wired communication function. The communication unit 24 supports, for instance one or multiple types of communication system, and may communicate with a communication partner in accordance with a communication system suitable for the communication partner (in other words, a communication system supported by the communication partner). As the communication system, for instance, the above-described communication systems are used. The communication unit 24 may change a communication system and/or a frequency band according to a communication partner or according to the surrounding environment.

An UI unit 26 is a user interface unit, and includes a display and an operation unit. The display is a display device such as a liquid crystal display. The display may be a flexible display. The operation unit is an input device such as a touch panel or a keyboard. The UI unit 26 may be a user interface serving as both a display and an operation unit. Also, the UI unit 26 may include a sound collector and a sound generator. In this case, information may be inputted to the device 12 by voice input, and information may be outputted by voice. The information processing system may include a device 12 which has no UI unit 26. For instance, a sensing device, which outputs no information to a user does not need to have the UI unit 26.

A storage 28 is a storage device such as a hard disk or a memory. In the storage 28, for instance, various types of data and various types of programs are stored. As the program, for instance, an OS, various application software, an automatic conversation program for implementing a chatbot, and a personal assistant program are stored. It is to be noted that when the personal assistant has the function of chatbot, the personal assistant program includes an automatic conversation program. No automatic conversation program is stored in the device 12 having no function of chatbot. Also, a device 12, in which a personal assistant is not mounted, stores no personal assistant program. Also, the storage 28 may store terminal address information (for instance, an IP address or a MAC Address) indicating the terminal apparatus 10, device address information on another device 12, and server address information. Each program is associated with program identification information for identifying the program.

The execution unit 30 is configurated to execute a function. For instance, when the device 12 is an image forming apparatus, the execution unit 30 executes an image forming function, such as a scan function, a print function, and a copy function. When the device 12 is a robot, the execution unit 30 executes a function of the robot (for instance, a moving function or a lifting function). When the device 12 is a camera, the execution unit 30 executes a photographing function.

A changer 32 is configurated to change a program portion. The changer 32 may automatically change a program portion in accordance with a request for change of setting. As another example, a candidate group for processing (commands, functions) corresponding to the content of change of setting may be provided to a user, and the changer 32 may reflect processing selected from the candidate group by a user in the program portion. As still another example, the changer 32 may generate a candidate group for program portion in which change in accordance with a request for change of setting has been reflected. In this case, the candidate group is provided to a user, and the changer 32 identifies a candidate as a post-change program portion, the candidate being selected from the candidate group by the user.

A controller 34 is configurated to control the operation of each component of the device 12. For instance, the controller 34 performs execution of a program, control of communication performed by the communication unit 24, control of notification (for instance, display and voice output of information) of information using the UI unit 26, receiving of information inputted to the device 12 using the UI unit 26, writing of information to the storage 28, and reading of information from the storage 28.

In addition, the controller 34 is configurated to control notification of the current setting information of a program portion to which the change of setting is to be made. The controller 34 may display on the display of the UI unit 26 a character string showing the setting information of the program portion or a graphic showing the setting information of the program portion.

Change processing for a program portion may be performed by the changer 20 of the terminal apparatus 10 or by the changer 32 of the device 12. When change processing is performed by the changer 20 of the terminal apparatus 10, the changer 32 does not need to be provided in the device 12. Similarly, when change processing is performed by the changer 30 of the device 12, the changer 20 does not need to be provided in the terminal apparatus 10. Also, change processing for a program stored in the terminal apparatus 10 may be performed by the changer 20 of the terminal apparatus 10, and change processing for a program stored in the device 12 may be performed by the changer 32 of the device 12.

Hereinafter, the robot as an example of the device 12 will be described in detail with reference to FIG. 4. FIG. 4 illustrates the appearance of a robot. A robot 12A corresponds to an example of the device 12.

The robot 12A is a humanoid robot as an example. It goes without saying that the robot 12A may be a robot other than a humanoid robot. In the example indicated in FIG. 4, the robot 12A includes a trunk 36, a head 38 provided on the trunk 36, legs 40 provided below the trunk 36, arms 42 provided on both sides of the trunk 36, and fingers 44 provided at respective front ends of the arms 42.

For instance, the robot 12A has at least one of a visual sensor, an auditory sensor, a tactile sensor, a taste sensor, and an olfaction sensor. It is sufficient that the robot 12A have an ability related to at least one of visual sense, auditory sense, tactile sense, taste sense, and olfactory sense corresponding to the five senses of a human. The robot 12A, may have a function of detecting biological information such as brain waves, pulse waves, or fingerprint. The head 38, the arms 42, and the fingers 44 may react and move like a human.

The legs 40 correspond to an example of a movement unit, and are configurated to drive by, for instance, driving force from a drive source such as a motor. The robot 12A can move by the legs 40. The legs 40 may have a shape like a human leg, may be a roller or a tire, or may have another shape. As a movement unit other than the legs 40, the robot 12A may have, for instance, a component for flying (for instance, a propeller, wings, an engine for flying), or a component for moving underwater (for instance, an engine for moving underwater). It goes without saying that the robot 12A does not need to have a movement unit.

The robot 12A may have a function of grasping or operating an object by the arm 42 or the fingers 44, or may have a function of moving while grasping or holding an object. Alternatively, the robot 12A may have a function of creating voice. The robot 12A may have a display 48. On the display 48, various images, messages and the like are displayed. The display 48 may be a user interface (for instance, a touch panel) which also serves as an operation unit. The display 48 may a function of projecting an image or a function of capturing an image. The display 48 may a function of identifying a user who utters voice based on the voice inputted to the robot 12A.

In addition, the personal assistant described above may be mounted in the robot 12A, and the personal assistant may control the robot 12A, or may exchange messages with a user.

In addition, the robot 12A may control another device 12, and may operate another device 12. For performing the control and the operation, the personal assistant mounted in the robot 12A may be used. Also, the robot 12A may obtain various types of information by utilizing the Internet or the like.

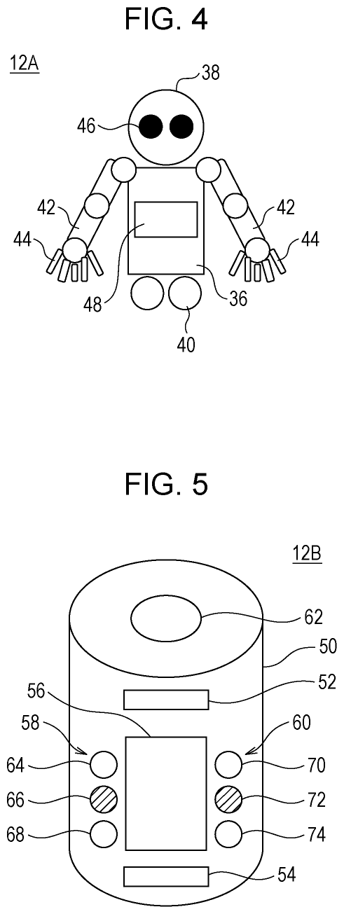

Hereinafter, a speaker device as an example of the device 12 will be described in detail with reference to FIG. 5. FIG. 5 illustrates the appearance of the speaker device. A speaker device 12B corresponds to an example of the device 12.

The speaker device 12B is a so-called smart speaker, and has a communication function and an assist function using voice. The speaker device 12B includes a pillar-shaped main body 50. The lateral surface of the main body 50 is provided with a microphone 52, a speaker 54, a display 56, and light emitters 58, 60. Also, the upper surface of the main body 50 is provided with a sensor 62. It is to be noted that the shape of the main body 50 is not limited to the shape illustrated in FIG. 5. As long as a speaker device includes the microphone 52 and the speaker 54, the speaker device may have any shape. Also, the microphone 52, the speaker 54, the display 56, the light emitters 58, 60, and the sensor 62 may be disposed at positions other than the positions illustrated in FIG. 5.

The microphone 52 functions as a sound collecting device, and collects sound around the speaker device 12B. For instance, voice of users is collected by the microphone 52.

When a personal assistant is mounted in the speaker device 12B, and a user has a conversation with the personal assistant, the content of an utterance of the personal assistant is outputted from the speaker 54 as the voice. Also, music, the voice of a television, and the voice of a radio may be outputted from the speaker 54.

The display 56 is a display device. On the display 56, various images, messages and the like are displayed. The display 56 may be a user interface (for instance, a touch panel) which also serves as an operation unit.

The light emitter 58 includes one or multiple light sources (for instance, light sources 64, 66, and 68), and emits light in accordance with an emission manner according to the setting of the personal assistant mounted in the speaker device 12B. For instance, age, sex, occupation, and/or character are set to the personal assistant as setting items. The personal assistant answers to a user and performs a task in accordance with the setting items. For instance, when doctor is set as the occupation setting item, the light sources 64, 68 emit blue light, and the light source 66 emits yellow light. When another setting item is set, the light emitter 58 emits light in accordance with an emission manner according to the setting.

A light emitter 60 includes one or multiple light sources (for instance, light sources 70, 72, and 74), and emits light in accordance with an emission manner according to a user account which logs in the personal assistant mounted in the speaker device 12B. For instance, when a user logs in the personal assistant mounted in the speaker device 12B, the light sources 70, 74 emit blue light, and the light source 72 emits yellow light. When another user logs in the personal assistant, the light emitter 60 emits light in accordance with an emission manner according to the user.

The light emitters 58, 60 may be provided in the main body 50 without being distinguished. For instance, the content of setting of the personal assistant and the user account may be indicated using all light sources included in the light emitters 58, 60. Also, the content of setting of the personal assistant and the user account may be indicated by a light emission pattern (for instance, a blinking manner, a time length) of each light source.

The sensor 62 detects a gesture of a user. The speaker device 12B performs processing in accordance with the detected gesture. For instance, the speaker device 12B may perform processing by itself in accordance with the detected gesture, or may control the operation of another device 12.

Another device 12 may be connected to the speaker device 12B. In this case, the speaker device 12B may be used as a repeater. The speaker device 12B may control, for instance, another device 12 (for instance, hardware of the device 12 or software installed in the device 12) connected to the speaker device 12B. Also, the speaker device 12B may obtain various types of information by utilizing the Internet or the like. The speaker device 12B may function as a server, or may perform management of data. The speaker device 12B may be installed indoors (for instance, the floor, the ceiling of a room, or a table), or may be installed in outdoors. The speaker device 12B may be a movable device (for instance, an automatic device).

Hereinafter, the processing performed by an information processing system according to the exemplary embodiment will be described in detail. In the exemplary embodiment, a program portion stored in the terminal apparatus 10 may be changed, or a program portion stored in the device 12 may be changed. When a program portion stored in the terminal apparatus 10 is changed, the program portion to which the change of setting is to be made may be a program for controlling the device 12 connected to the terminal apparatus 10, or a program which is not for controlling the device 12. When a program portion stored in the device 12 is changed, the program portion to which the change of setting is to be made may be a program for controlling the device 12, or a program for controlling another device 12 connected to the device 12. Hereinafter, as an example, the processing when a program portion for controlling the robot 12A is changed will be described. The program portion is assumed to be stored in the robot 12A.

A user operates the terminal apparatus 10, and thereby instructing the terminal apparatus 10 to connect between the terminal apparatus 10 and the robot 12A. The controller 22 of the terminal apparatus 10 transmits information indicating a connection request to the robot 12A in accordance with the instruction, thereby establishing communication between the terminal apparatus 10 and the robot 12A.

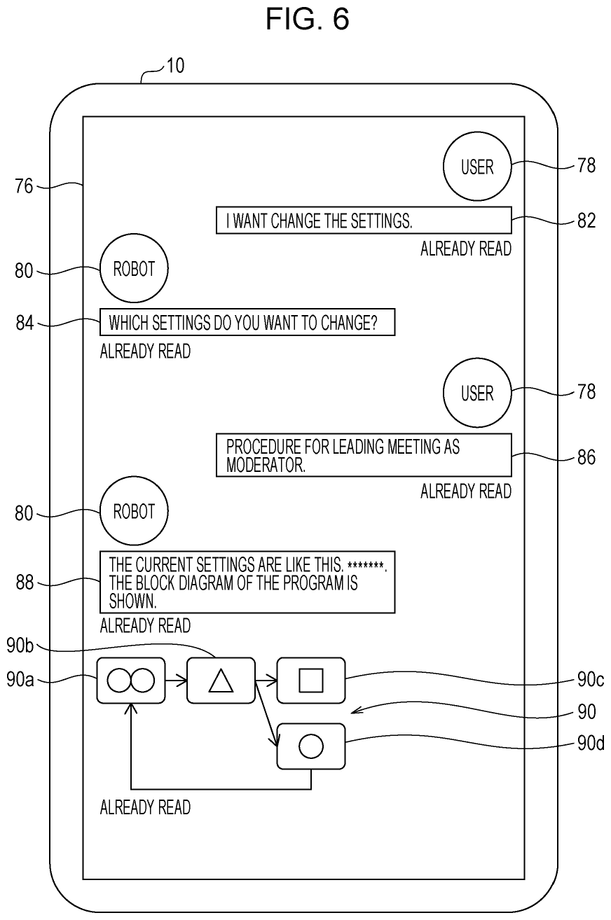

When communication is established between the terminal apparatus 10 and the robot 12A, the controller 22 of the terminal apparatus 10 causes the display of the UI unit 16 of the terminal apparatus 10 to display a screen for exchanging messages between the personal assistant mounted in the robot 12A and the user. FIG. 6 illustrates an example of the screen.

The controller 22 of the terminal apparatus 10 causes the display of the UI unit 16 to display a screen 76, and displays various types of information on the screen 76. The screen 76 is a user interface (conversational user interface) for a user to have a conversation with the personal assistant. On the screen 76, information (for instance, a character string, an image) inputted to the terminal apparatus 10 by a user, and information (for instance, a character string, an image) indicating the content of an utterance of the personal assistant are displayed. Conversation between the user and the personal assistant is a so-called chat format conversation (specifically, a conversation format in which the user and the personal assistant alternately talk to have a conversation).

For instance, when a user inputs information to the terminal apparatus 10 on the screen 76, the terminal apparatus 10 transmits the information to the robot 12A. The personal assistant (for instance, a chatbot) mounted in the robot 12A analyzes the information transmitted from the terminal apparatus 10 to recognize the content of an utterance of the user, and creates the content of an utterance, such as an answer to the content of the utterance of the user. The robot 12A transmits information indicating the content of an utterance of the personal assistant to the terminal apparatus 10. The controller 22 of the terminal apparatus 10 displays the information on the screen 76 as the content of the utterance of the personal assistant.

The controller 22 of the terminal apparatus 10 displays an image 78 (for instance, an icon or a photograph) associated with the user on a display area for users of the screen 76. Similarly, the controller 22 displays an images 80 (for instance, an icon) associated with the personal assistant (for instance, a chatbot) mounted in the robot 12A on a display area for personal assistants. Instead of the image or along with the image, a character string for identifying the user and a character string for identifying the personal assistant may be displayed.

On the screen 76, a conversation is held between a user and a personal assistant (chatbot). When the conversation is held, the controller 22 displays the content of an utterance of a user on the screen 76 in association with the screen 78, and displays the content of an utterance of the personal assistant on the screen 76 in association with the screen 80. When the content of the utterance of a user is recognized by the personal assistant, the content of the utterance is assumed to be read, and information (for instance, the character string “already read”) indicating that the content has been read by the personal assistant is displayed in association with the content of the utterance of the user. Also, when the content of an utterance of the personal assistant is read by a user (for instance, when a user specifies the content of an utterance on the screen 76), the content of the utterance is assumed to be read by a user, and information indicating that the content has been read by the user is displayed in association with the content of the utterance of the personal assistant.

It is to be noted that another user may participate in the conversation between a user and a personal assistant, and another personal assistant may participate.

A user may input the content of an utterance to the terminal apparatus 10 by inputting information to the terminal apparatus 10 with a keyboard included in the operation unit of the UI unit 16, may input the content of an utterance to the terminal apparatus 10 by voice, or may input the content of an utterance to the terminal apparatus 10 by gesture. Gesture is captured by, for instance, a camera provided in the terminal apparatus 10, a camera provided in the periphery of the terminal apparatus 10, or a camera provided in the device 12. Also, the content of an utterance of a personal assistant may be outputted by voice from the terminal apparatus 10 or the robot 12A, or the content may be expressed by gesture of a personal assistant. Also, the content of an utterance of a personal assistant may be displayed on the display (for instance, the display 48) of the UI unit 26 of the robot 12A without being displayed on the screen 76.

When voice or gesture is used for a conversation, the screen 76 does not need to be displayed. It goes without saying that the screen 76 may be displayed on the display of the UI unit 16, and the content of the voice and the content of the gesture may be displayed on the screen 76.

A request for change of setting of a program portion is made by a user on the screen 76. For instance, when a user makes a request for change of setting of a program portion as the content of the utterance 82, information indicating the content of the utterance 82 is transmitted from the terminal apparatus 10 to the robot 12A. A personal assistant mounted in the robot 12A analyzes the content of the utterance 82, and generates a content of an utterance 84 including an answer. Information indicating the content of the utterance 84 is transmitted from the robot 12A to the terminal apparatus 10, and is displayed on the screen 76. Display control for the content of each utterance is performed by the controller 22 of the terminal apparatus 10. The same goes with the following conversation.

When a user inputs program identification information for identifying a program portion to which change of setting is to be made as the content of the utterance 86, the personal assistant identifies a program portion associated with the program identification information. For instance, the personal assistant identifies a program portion from a program group stored in the storage 28 of the robot 12A, the program portion being associated with the program identification information specified by a user. In the example illustrated in FIG. 6, a program portion for executing “the procedure for leading a meeting” is specified by user, thus the personal assistant identifies the program portion. The identification of a program portion may be performed by the controller 34 of the robot 12A.

Information (setting information) indicating the current content of setting of the program portion is transmitted from the terminal apparatus 10 to the robot 12A, and the information is displayed on the screen 76 as a content of an utterance 88 of the robot 12A.

Also, a block diagram 90 indicating the current content of setting is displayed on the screen 76 as the content of an utterance of the robot 12A. The block diagram 90 is an example of representative form of the program portion “the procedure for leading a meeting”, and is a set of graphics (for instance, nodes) each associated with processing. For instance, the block diagram 90 includes graphics 90a, 90b, 90c, and 90d. The graphics 90a, 90b, 90c, and 90d are graphics showing different processing. Some two graphics are connected by a line such as an arrow showing flow of processing.

For instance, the graphic 90a and the graphic 90b are connected by an arrow pointing from the graphic 90a to the graphic 90b. The graphic 90b and the graphic 90c are connected by an arrow pointing from the graphic 90b to the graphic 90c. The graphic 90b and the graphic 90d are connected by an arrow pointing from the graphic 90b to the graphic 90d. The graphic 90d and the graphic 90a are connected by an arrow pointing from the graphic 90d to the graphic 90a. In this example, the processing associated with the graphic 90a is executed, and a processing result is passed to the processing associated with the graphic 90b. The processing associated with the graphic 90b is performed using the processing result. Similarly, a result of the processing associated with the graphic 90b is passed to respective processing associated with the graphics 90c, 90d, and the respective processing associated with the graphics 90c, 90d are performed. Also, a result of the processing associated with the graphic 90d is passed to the processing associated with the graphic 90a.

It is to be noted that a program portion may be represented in accordance with the representative form of source code, and may be stored in the robot 12A, or may be represented in accordance with the representative form of block diagram, and may be stored in the robot 12A. The same goes with a program portion stored in the terminal apparatus 10 and another device 12.

When a program portion is represented and stored in accordance with the representative form of source code, the representative form of the program portion may be converted from the representative form of source code to the representative form of block diagram, and a block diagram after conversion may be displayed on the screen 76. Similarly, when a program portion is represented and stored in accordance with the representative form of block diagram, the representative form of the program portion may be converted from the representative form of block diagram to the representative form of source code, and a block diagram after conversion may be displayed on the screen 76. The conversion processing may be performed by the controller 22 of the terminal apparatus 10, or may be performed by the controller 34 of the robot 12A. For instance, processing represented by a character string as a source code, and processing represented by a graphic are associated with each other, and information indicating a correspondence relationship between those processing is stored in the terminal apparatus 10 and the device 12. The controller 22 or the controller 34 refers to the information indicating the correspondence relationship, thereby converting a source code and a block diagram from one to the other. It is to be noted that the information indicating the correspondence relationship may be stored in an external apparatus such as a server. In this case, the controller 22 or the controller 34 obtains the information indicating the correspondence relationship from the external apparatus, and performs conversion processing.

The block diagram 90 illustrated in FIG. 6 may be represented in accordance with the representative form of block diagram, and may be stored in the robot 12A, or may be diagram which is generated by converting a program portion represented in accordance with the representative form of source code into the representative form of block diagram.

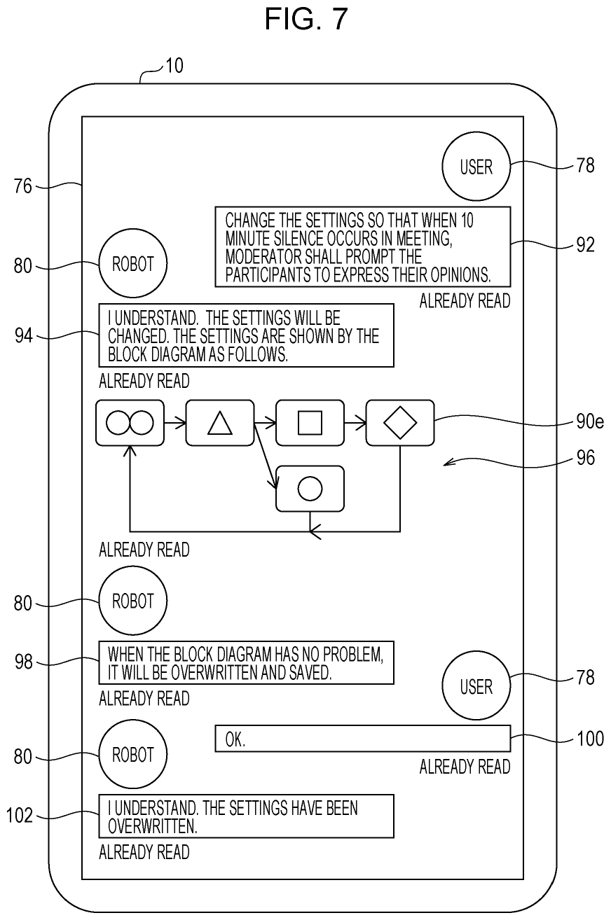

Hereinafter, continuing part of the conversation will be described with reference to FIG. 7. FIG. 7 illustrates an example of a screen. When a user inputs a specific content of change of the program portion “the procedure for leading a meeting” as the content of an utterance 92, information indicating the content of change is transmitted from the terminal apparatus 10 to the robot 12A. The changer 32 of the robot 12A interprets the content of change, and changes the program portion based on a result of the interpretation. For the interpretation, natural language processing such as a morphological analysis is used. It is to be noted that the personal assistant mounted in the robot 12A may interpret the content of setting.

For instance, the changer 32 identifies a section to be changed in the program portion “the procedure for leading a meeting” in accordance with a request for change of setting, and adds processing corresponding to the content of change specified by a user to the section to be changed, changes processing at the section to be changed, or deletes the processing at the section to be changed. The change processing of the content of setting may be performed by the changer 20 of the terminal device 10.

When a request for change of setting is made by a user, information indicating an intention of making change of setting is displayed on the screen 76 as the content of an utterance 94 of the personal assistant. Also, a program portion in which the change in accordance with a request for change of setting has been reflected is displayed on the screen 76. In the example illustrated in FIG. 7, a block diagram 96 showing the program portion in which the change has been reflected is displayed on the screen 76. A graphic 90e associated with processing corresponding to the content of change is newly added to the original block diagram 90, thereby generating the block diagram 96. The block diagram 96 is generated by the controller 22 or the controller 34.

A graphic 90e is associated with the processing of “when 10 minute silence occurs in meeting, the moderator shall prompt the participants to express their opinions”, and an arrow indicating a flow of the processing is drawn in the block diagram 96.

A message for asking a user whether or not overwrite save is performed is displayed on the screen 76 as the content of an utterance 98 of the personal assistant. When a user instructs overwrite save for the content of the utterance 98 as the content of an utterance 100, the changer 32 of the robot 12A overwrites the program portion in which the change has not been reflected with the program portion in which the change has been reflected, and stores the program portion in the storage 28. When the overwrite save is completed, the content of an utterance 102 indicating the completion of overwriting is displayed on the screen 76. It goes without saying that a program portion in which the change has been reflected and a program portion in which the change has not reflected may be stored separately in the storage 28.

The program portion in which the change has been reflected may be stored in the storage 28 with represented in the representative form of source code, or may be stored in the storage 28 with represented in the representative form of block diagram.

The robot 12A may show reaction by head shaking, gesture, and light emission sound under the control by the personal assistant. For instance, when change of the program portion is possible, the robot 12A may shake its head, and when change of the program portion is not possible, the robot 12A may nod its head. When the program portion in which the change has been reflected is overwritten and saved, the robot 12A may nod its head.

When messages are exchanged between a user and a personal assistant by voice or gesture, the screen 76 does not need to be displayed on the terminal apparatus 10. Also in this case, when a user instructs message exchange display, or when change of setting of a program portion is completed, the screen 76 showing the exchange of messages so far may be displayed on the terminal apparatus 10.

As described above, according to the exemplary embodiment, programming is performed using a conversational user interface. Consequently, a user can easily perform programming while having a conversation with a conversation partner.

When a program portion to be changed is described by a compile language, after the change has been reflected in the program portion, before the program portion in which the change has been reflected is executed, the controller 34 of the robot 12A may compile the program portion in which the change has been reflected to convert the program portion to a machine language. By compiling the program portion in advance, the time taken for execution of the program portion can be reduced, as compared with when the program portion is compiled at the time of execution of the program portion.

Although a program portion stored in the device 12 is changed in the example above, a program portion stored in the terminal apparatus 10 may be changed. In this case, the terminal device 10 does not need to be connected to the device 12. Exchange of messages between the personal assistant mounted in the terminal apparatus 10 and a user allows a program portion stored in the terminal apparatus 10 to be changed. The screen 76 is used as the user interface for exchanging the messages. Also in this case, messages may be exchanged between a user and the personal assistant by voice or gesture. In this case, the screen 76 may be displayed or may not be displayed then but may be displayed later

When the content of change of setting is not possible to be executed by the device 12 (for instance, the robot 12A), the controller 22 of the terminal apparatus 10 may cause the display of the UI unit 16 to display information indicating that change of setting is not possible. For instance, the controller 34 of the robot 12A determines whether or not the robot 12A has a function corresponding to the content of change of setting. When the robot 12A does not have the function, the controller 34 transmits the information indicating the situation to the terminal device 10. The controller 22 of the terminal device 10 displays on Screen 76 the information indicating the situation. For instance, the storage 28 of the robot 12A stores information indicating the functions owned by the robot 12A, and the controller 34 refers to the information, thereby determining whether or not the robot 12A has a function corresponding to the content of change of setting. It goes without saying that the controller 22 of the terminal apparatus 10 may perform the determination above. When a request for change of setting of a program portion stored in the terminal apparatus 10 is made, and the terminal apparatus 10 does not have a function corresponding to the content of change of setting, the controller 22 may cause the display of the UI unit 16 to display information indicating that the content of change of setting is not possible to be executed by the terminal apparatus 10.

Hereinafter, a modification will be described.

(First Modification)

A first modification will be described. In the first modification, a user is notified of one or multiple candidates for the processing corresponding to the content of change of setting. A candidate selected from one or multiple candidates by a user is newly added to the program portion, or processing included in a program portion is changed to the candidate.

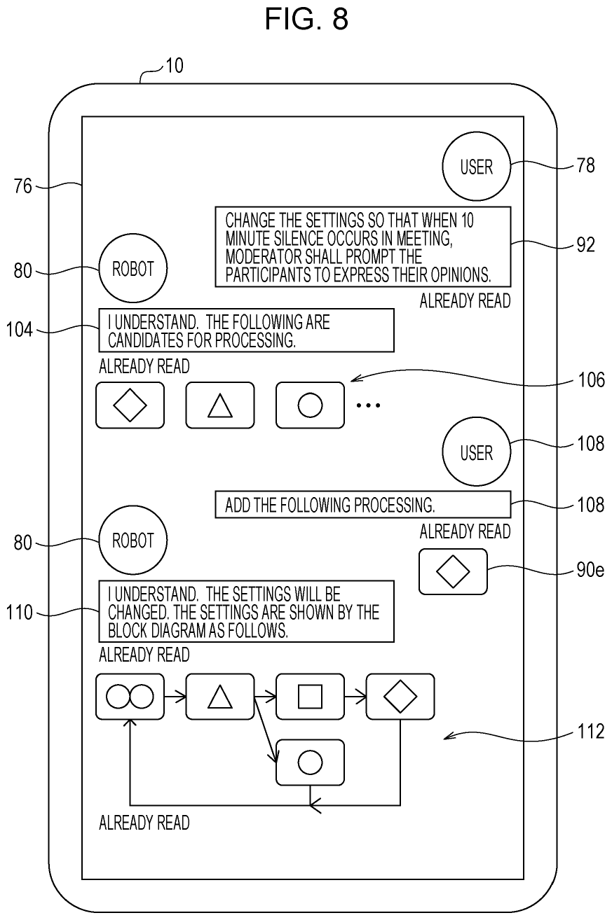

Hereinafter, the first modification will be described in detail with reference to FIG. 8. FIG. 8 illustrates an example of a screen. Here, similarly to the exemplary embodiment described above, “the procedure for leading a meeting” which is the program portion stored in the robot 12A is to be changed.

When a user inputs a specific content of change of the program portion “the procedure for leading a meeting” as the content of an utterance 92, information indicating the content of change is transmitted from the terminal apparatus 10 to the robot 12A. The changer 32 of the robot 12A interprets the content of change, and identifies one or multiple candidates for the processing corresponding to the content of change. The changer 32 may identify processing as a candidate, the processing being the same as or similar to the content indicated by a result of the interpretation. Each candidate may be represented in accordance with the representative form of source code, or may be represented in accordance with the representative form of graphic (for instance, node) associated with processing. For the interpretation, natural language processing such as a morphological analysis is used. It is to be noted that the personal assistant mounted in the robot 12A may interpret the content of change. The information indicating one or multiple candidates for each processing is pre-stored in the device 12, and the changer 32 identifies the candidates by referring to the information.

When information (information represented by source codes or graphics) indicating candidates for each processing is pre-stored in the robot 12A, the changer 32 identifies one or multiple candidates from a candidate group stored in the robot 12A, the one or multiple candidates being for the processing corresponding to the content of change. As another example, the changer 32 may generate a candidate for the processing corresponding to the content of change.

For instance, when information indicating a candidate for processing, “when 10 minute silence occurs in meeting, moderator shall prompt the participants to express their opinions” is pre-stored in the robot 12A, the changer 32 identifies the candidate from a candidate group stored in the robot 12A. As another example, the changer 32 may generate the candidate.

The changer 20 of the terminal apparatus 10 may interpret the content of change, and may identify one or multiple candidates for the processing corresponding to the content of change. For instance, information indicating one or multiple candidates for each processing is re-stored in the terminal apparatus 10, and the changer 20 may identify the candidates by referring to the information.

The information (information represented by source codes or graphics) indicating one or multiple candidates identified is transmitted from the robot 12A to the terminal apparatus 10. The controller 22 of the terminal apparatus 10 displays the information on the screen 76. For instance, subsequent to the content of an utterance 104 of the personal assistant, information indicating candidates are displayed. Here, a candidate group 106 represented by graphics (for instance, nodes) is displayed. It goes without saying that a candidate group represented by source codes may be displayed.

When a user selects a specific candidate (for instance, the graphic 90e) from the candidate group 106 with the content of an utterance 108, and designates a section to be changed in the original block diagram 90, information indicating the selection and designation is transmitted from the terminal apparatus 10 to the robot 12A. The changer 32 adds the processing associated with the graphic 90e to the portion to be changed in the program portion represented by the original block diagram 90 in accordance with the selection and designation.

On the screen 76, information indicating an intention of making change of setting is displayed as the content of an utterance 110 of the personal assistant. Also, a program portion in which the change has been reflected is displayed on the screen 76. For instance, a block diagram 112 showing the program portion in which the change has been reflected is displayed on the screen 76. A graphic 90e associated with processing corresponding to the content of change is newly added to the original block diagram 90, thereby generating the block diagram 112. The block diagram 112 is generated by the controller 22 or the controller 34.

According to the first modification, a candidate for the processing corresponding to the content of change is presented to a user, thus the program portion can be easily changed.

When it is not possible to notify of a candidate (for instance, when a candidate is not stored in the robot 12A, and when a candidate, when a candidate may not be generated), the robot 12A may tell a user that it is not possible to notify of a candidate by shaking its head.

Also when a program portion stored in the terminal apparatus 10 is changed, similarly the example above, a candidate for the processing corresponding to the content of change is presented to a user.

(Second Modification)

A second modification will be described. In the second modification, a user is notified of a candidate for program portion in which change in accordance with a request for change of setting has been reflected. A candidate selected from one or multiple candidates by a user is stored as a program portion in which the change has been reflected.

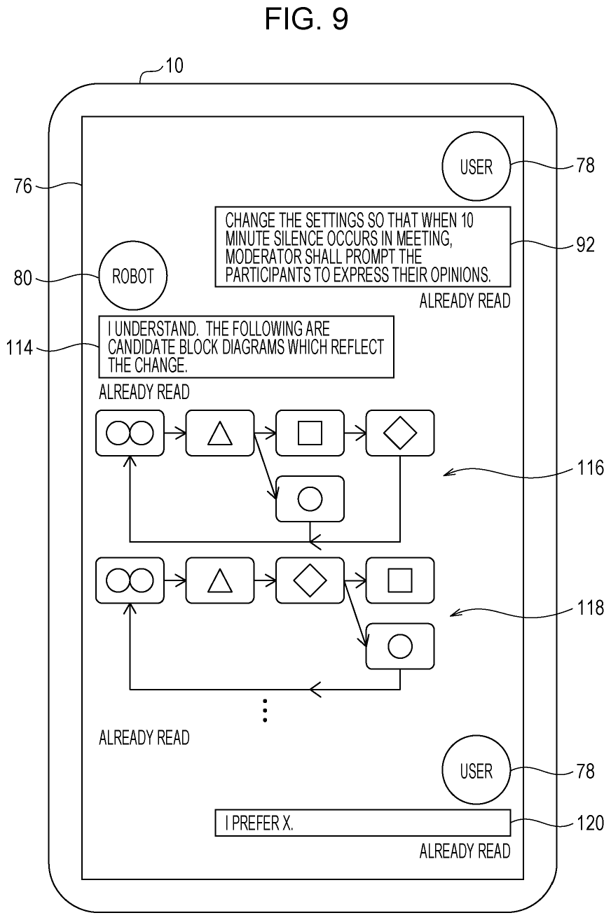

Hereinafter, the second modification will be described in detail with reference to FIG. 9. FIG. 9 illustrates an example of a screen. Here, similarly to the exemplary embodiment described above, the content of setting of “the procedure for leading a meeting” as the program portion stored in the robot 12A is to be changed.

When a user inputs a specific content of change of the program portion “the procedure for leading a meeting” as the content of an utterance 92, information indicating the content of change of setting is transmitted from the terminal apparatus 10 to the robot 12A. The changer 32 of the robot 12A interprets the content of change, and changes the content of setting of the program portion based on a result of the interpretation, thereby generating one or multiple candidates for program portion in which the change has been reflected. Each candidate may be represented in the form of source code, or may be represented in the form of graphics (for instance, nodes) associated with processing. For the interpretation, natural language processing such as a morphological analysis is used. It is to be noted that the personal assistant mounted in the robot 12A may interpret the content of setting.

For instance, the changer 32 identifies a section to be changed in the program portion “the procedure for leading a meeting” in accordance with a result of the interpretation of the content of change, and adds processing corresponding to the content of change specified by a user to the section to be changed, changes processing at the section to be changed, or deletes the processing at the section to be changed, thereby generating one or multiple candidates for the program portion. The change processing of the content of setting may be performed by the changer 20 of the terminal device 10.

The information (information represented by source codes or graphics) indicating one or multiple candidates for the program portion in which the change has been reflected is transmitted from the robot 12A to the terminal apparatus 10, and displayed on the screen 76. For instance, subsequent to the content of an utterance 114 of the personal assistant, information indicating candidates are displayed. Here, candidates 116,118 represented by a block diagram (for instance, a set of nodes) are displayed. It goes without saying that a candidate group represented by source codes may be displayed.

When a user selects a specific candidate (for instance, the candidate 116) from the candidates 116,118 with the content of an utterance 120, information indicating the selection is transmitted from the terminal device 10 to the robot 12A. The changer 32 overwrites the program portion in which the change has not reflected with the program portion indicated by the candidate 116 in accordance with the selection, and stores the program portion in the storage 28. When the overwrite save is completed, the content of an utterance indicating the completion of overwriting is displayed on the screen 76. It goes without saying that a program portion in which the change has been reflected and a program portion in which the change has not reflected may be stored separately in the storage 28.

Similarly to the exemplary embodiment described above, the program portion in which the change has been reflected may be stored in the storage 28 with represented in the form of source code, or may be stored in the storage 28 with represented in the form of block diagram.

According to the second modification, a candidate for program portion in which the change has been reflected is presented to a user, thus the program portion can be easily changed.

Similarly to the first modification, when it is not possible to notify of a candidate, the robot 12A may tell a user that it is not possible to notify of a candidate by shaking its head.

Also when a program portion stored in the terminal apparatus 10 is changed, similarly the example above, one or multiple candidates for the program portion in which the change has been reflected are presented to a user.

(Third Modification)

A third modification will be described. In the third modification, the content of change of setting is given by a character string described using a programming language.

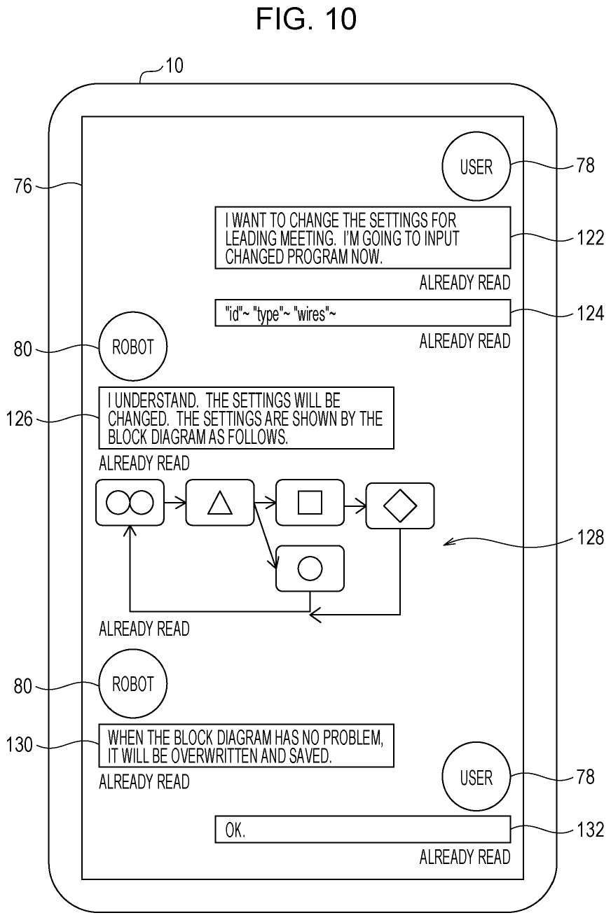

Hereinafter, the third modification will be described in detail with reference to FIG. 10. FIG. 10 illustrates an example of a screen. Here, similarly to the exemplary embodiment described above, the content of setting of “the procedure for leading a meeting” as the program portion stored in the robot 12A is to be changed.

When a user designates “the procedure for leading a meeting” which is the program portion to be changed as the content of an utterance 122, and subsequently, inputs the content of change of setting described using program language as the content of an utterance 124, information indicating the content of change of setting is transmitted from the terminal apparatus 10 to the robot 12A. Here, the content of change of setting is represented in the representative form of source code.

The changer 32 of the robot 12A identifies a section to be changed in the program portion “the procedure for leading a meeting” based on a command sentence (a character string represented by source code) included in the content of the setting change, and adds the command sentence to the program portion.

The changer 32 adds a command sentence (a character string represented by source code) included in the content of the setting change to the original program portion represented in the representative form of source code. Consequently, the program portion in which the change has been reflected is represented in the representative form of source code. The controller 34 may convert the post-change program portion represented in the representative form of source code to a block diagram represented by graphics (for instance, nodes). As another example, the changer 32 converts a command sentence (a character string represented by source code) included in the content of the setting change to a graphic (for instance, nodes), and may add the graphic after conversion to the pre-change program portion which is represented in representative form of graphic. The change processing of the content of setting may be performed by the changer 20 of the terminal device 10.

When a request for change of setting is made by user, information indicating an intention of making change of setting is displayed on the screen 76 as the content of an utterance 126 of the personal assistant. Also, the program portion in which change in accordance with a request for change of setting has been reflected is displayed on the screen 76. In the example illustrated in FIG. 10, a block diagram 128 showing the program portion in which the change has been reflected is displayed on the screen 76. It goes without saying that the program portion in which the change has been reflected may be represented in the representative form of source code, and may be displayed on the screen 76.

The content of an utterance 130 for asking a user whether or not overwrite save is performed is displayed on the screen 76, and when a user instructs overwrite save as the content of an utterance 132, the changer 32 of the robot 12A overwrites the program portion in which the change has not reflected with the program portion in which the change has been reflected, and stores the program portion in the storage 28.

According to the third modification, a program portion can be easily changed by inputting the content of change of setting represented using a program language.

A program portion stored in the terminal apparatus 10 may also be changed in the same manner as described above.

(Fourth Modification)

A fourth modification will be described. In the fourth modification, the content of setting of a program portion is transmitted to a transmission destination in accordance with transmission instructions for the program portion.

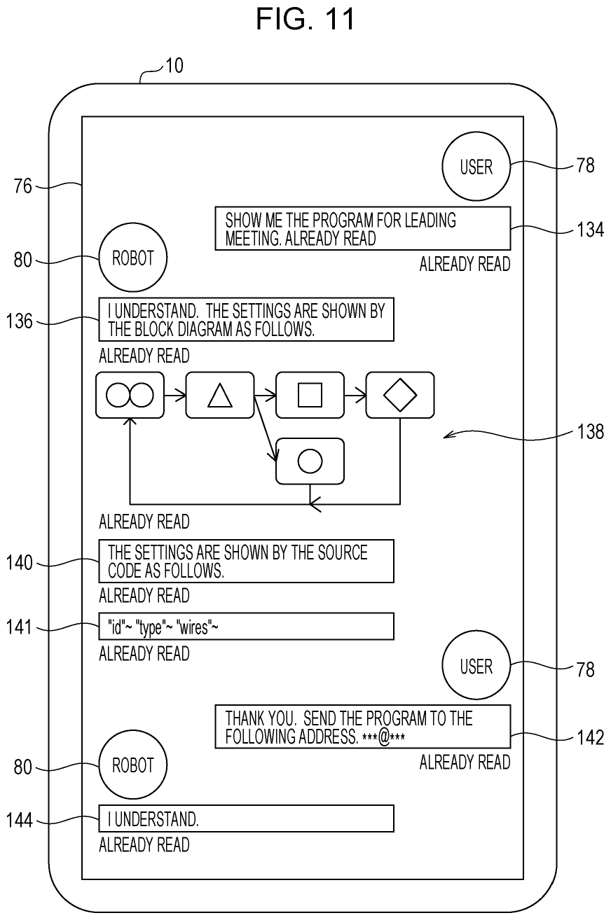

Hereinafter, the fourth modification will be described in detail with reference to FIG. 11. FIG. 11 illustrates an example of a screen. Here, similarly to the exemplary embodiment described above, the content of setting of “the procedure for leading a meeting” as the program portion stored in the robot 12A is to be changed.

When a user gives instructions for displaying the program portion “the procedure for leading a meeting” as the content of an utterance 134, information indicating the instructions is transmitted from the terminal apparatus 10 to the robot 12A. The controller 34 of the robot 12A identifies the program portion designated by a user from a program portion group stored in the robot 12A, and transmits information (information represented by source codes or graphics) indicating the program portion to the terminal apparatus 10. The program portion is displayed on the screen 76. For instance, subsequent to the content of an utterance 136 of the personal assistant, a block diagram 138 showing the program portion designated by a user is displayed. Also, the program portion is represented in the representative form of source code, and subsequent to the content of an utterance 140, a command sentence 141 (a character string represented by source code) showing the program portion is displayed on the screen 76.

When a user gives transmission instructions for a program portion by designating the address (such as the address of an E-mail) of a transmission destination as the content of an utterance 134, information indicating the transmission instructions is transmitted from the terminal apparatus 10 to the robot 12A. The controller 34 of the robot 12A transmits the program portion designated by a user to the address designated by the user in accordance with the transmission instructions. It is to be noted that the terminal apparatus 10 may transmit the program portion to the transmission destination.

Also, the controller 34 of the robot 12A may transmit the program portion to an apparatus such as a terminal apparatus in which a user account is set which is different from a user account that has given the transmission instructions. For instance, the controller 34 of the robot 12A transmits the program portion to the terminal apparatus of a user who has a user account registered in the robot 12A. In addition, the controller 34 of the robot 12A manages the usage history of each user who has an experience of using or changing setting of the program portion to be transmitted in the past, and may transmit the program portion to the terminal apparatus of the user.

In the example illustrated in FIG. 11, the content of an utterance 144 indicating that the personal assistant has received transmission instructions is displayed on the screen 76, and subsequently, the program portion is transmitted to a transmission destination.

The program portion to be transmitted may be represented by source code or may be represented by block diagram.

According to the fourth modification, transmission instructions for a program portion can be given using a conversational user interface.

A program portion stored in the terminal apparatus 10 may also be transmitted to a transmission destination in the same manner as described above.

(Fifth Modification)

A fifth modification will be described. In the fifth modification, the content of change of setting is given by a graphic which is associated with processing related to the change of setting.

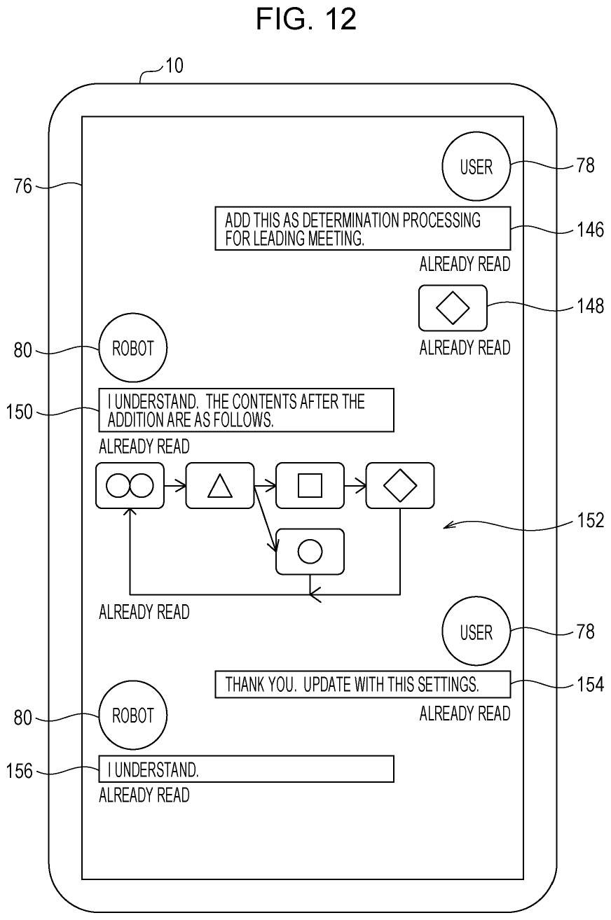

Hereinafter, the fifth modification will be described in detail with reference to FIG. 12. FIG. 12 illustrates an example of a screen. Here, similarly to the exemplary embodiment described above, the content of setting of “the procedure for leading a meeting” as the program portion stored in the robot 12A is to be changed.

When a user designates “the procedure for leading a meeting” which is the program portion to be changed as the content of an utterance 146, and subsequently, inputs a graphic 148 associated with processing to be added to determination in the procedure for leading a meeting, information indicating the content of change of setting is transmitted from the terminal apparatus 10 to the robot 12A. The information indicating the content of change of setting includes the information illustrated in the graphic 148, information indicating instructions for adding processing associated with the graphic 148, and information indicating a section (determination section in the procedure for leading a meeting) to which the graphic 148 (that is, the processing associated with the graphic 148) is added in the program portion to be changed.

The changer 32 of the robot 12A adds the graphic 148 included in the content of the change of setting to the section (determination section in the procedure for leading a meeting) to be changed in “the procedure for leading a meeting” as the program portion, in accordance with instructions for adding processing. The changer 32 adds the graphic 148 to the section to be changed in the program portion before change represented in the representative form of graphic. The change processing of the content of setting may be performed by the changer 20 of the terminal device 10.

Information indicating an intention of making change of setting is displayed on the screen 76 as the content of an utterance 150 of the personal assistant. Also, the program portion in which the change has been reflected is displayed on the screen 76. In the example illustrated in FIG. 12, a block diagram 152 showing the program portion in which the change has been reflected is displayed on the screen 76. It goes without saying that the program portion in which the change has been reflected may be represented in the representative form of source code, and may be displayed on the screen 76.

It is to be noted that the changer 32 may add the graphic 148 to the block diagram showing pre-change program portion, and may connect the added graphic 148 and other graphics by an arrow indicating a flow of processing. The connection may be made by a user.

When a user gives instructions for updating (for instance, overwrite save) a program portion as the content of an utterance 154, information indicating that the personal assistant has accepted the instructions is displayed on the screen 76 as the content of an utterance 156. The changer 32 of the robot 12A overwrites the program portion in which the change has not reflected with the program portion represented by the block diagram 152, and stores the program portion in the storage 28.

According to the fifth modification, a program portion can be easily changed by inputting the content of change of setting represented using graphics.

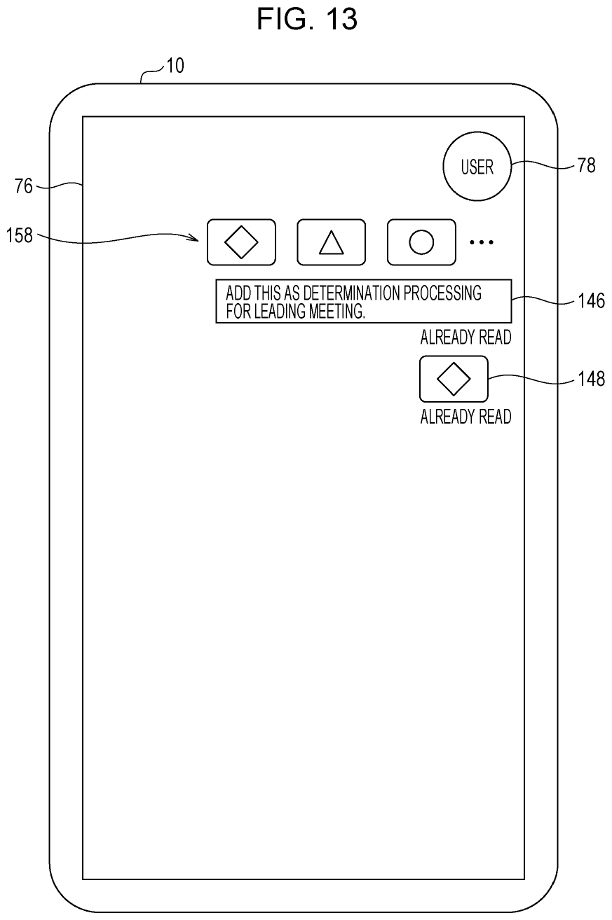

Also, the controller 22 of the terminal apparatus 10 may display a list 158 of graphics (for instance, nodes) representing processing on the screen 76 as illustrated in FIG. 13. The list 158 includes multiple graphics (for instance, nodes). When a user selects the graphic 148 associated with processing of interest from the list 158, the processing associated with the graphic 148 is added to the program portion to be changed. Thus, it is possible for a user to select processing of interest easily by displaying the list 158. It is to be noted that information indicating graphics included in the list 158 may be stored in the terminal apparatus 10, or stored in the device 12.

A program portion stored in the terminal apparatus 10 may also be changed in accordance with the content of change of setting represented using graphics.

(Sixth Modification)

A sixth modification will be described. In the sixth modification, processing for part of a program portion to be changed is deleted.

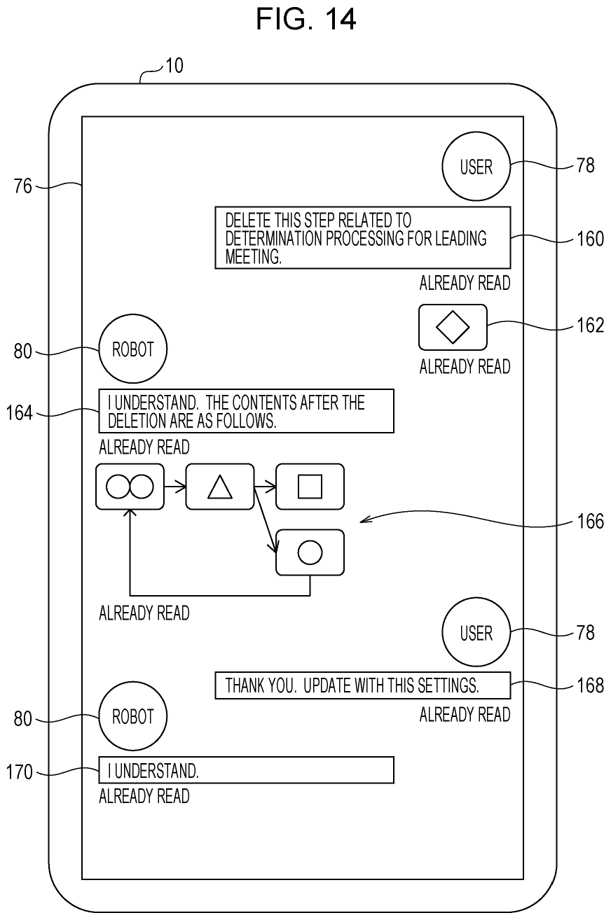

Hereinafter, the sixth modification will be described in detail with reference to FIG. 14. FIG. 14 illustrates an example of a screen. Here, similarly to the exemplary embodiment described above, the content of setting of “the procedure for leading a meeting” as the program portion stored in the robot 12A is to be changed.

When a user designates “the procedure for leading a meeting” which is the program portion to be changed as the content of an utterance 160, and subsequently, inputs a graphic 162 associated with processing to be deleted from determination in the procedure for leading a meeting, information indicating the content of change of setting is transmitted from the terminal apparatus 10 to the robot 12A. The information indicating the content of change of setting includes the information illustrated in the graphic 162, information indicating instructions for deleting processing associated with the graphic 162, and information indicating a section (determination section in the procedure for leading a meeting) to which the graphic 162 (that is, the processing associated with the graphic 162) is deleted in the program portion to be changed.

The changer 32 of the robot 12A deletes the graphic 162 included in the content of the change of setting to the section (determination section in the procedure for leading a meeting) to be changed in “the procedure for leading a meeting” as the program portion, in accordance with instructions for deleting processing. The changer 32 deletes the graphic 162 from the section to be changed in the program portion before change represented in the representative form of graphic. The change processing of the content of setting may be performed by the changer 20 of the terminal device 10.

Information indicating an intention of making change of setting is displayed on the screen 76 as the content of an utterance 164 of the personal assistant. Also, the program portion in which the change has been reflected is displayed on the screen 76. In the example illustrated in FIG. 14, a block diagram 166 showing the program portion in which the change has been reflected is displayed on the screen 76. It goes without saying that the program portion in which the change has been reflected may be represented in the representative form of source code, and may be displayed on the screen 76.

It is to be noted that in the block diagram after the graphic 162 is deleted, the changer 32 may connect graphics by an arrow indicating a flow of processing. The connection may be made by a user.

When a user gives instructions for updating (for instance, overwrite save) a program portion as the content of an utterance 168, information indicating that the personal assistant has accepted the instructions is displayed on the screen 76 as the content of an utterance 170. The changer 32 of the robot 12A overwrites the program portion in which the change has not reflected with the program portion represented by the block diagram 166, and stores the program portion in the storage 28.

As described above, according to the sixth modification, a program portion can be easily changed by inputting the content of change of setting represented using graphics.

Similarly to the processing described above, a program portion stored in the terminal apparatus 10 may also be changed in accordance with the content of change of setting represented using graphics.

(Seventh Modification)

A seventh modification will be described. In the seventh modification, when a program is generated and a program part in an operable unit is completed, notification of the situation is made.

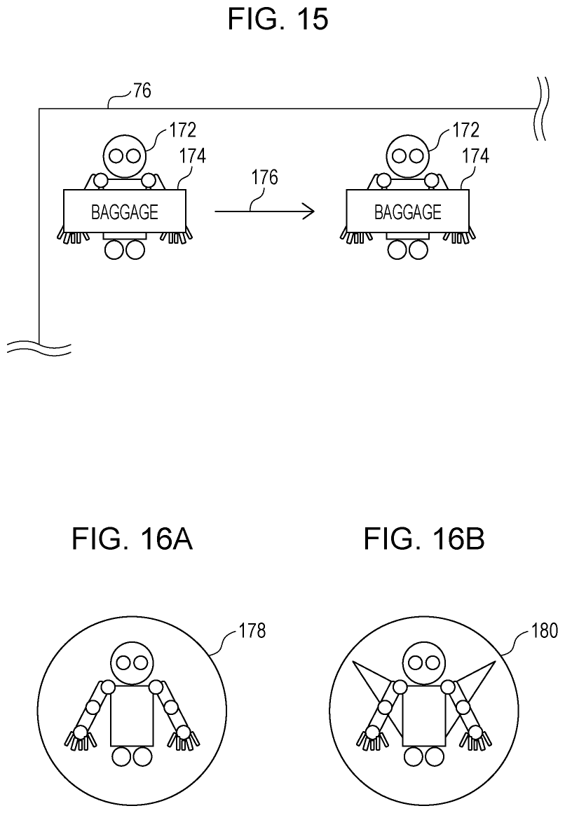

Hereinafter, the seventh modification will be described in detail with reference to FIG. 15. FIG. 15 illustrates part of a screen. For instance, in the case where a program portion is edited in the exemplary embodiment or the modifications described above or a program is generated by instructions of a user, when a program part in an operable unit is completed, the controller 22 of the terminal apparatus 10 controls notification of the situation. For instance, in the terminal apparatus 10, when a program part in an operable unit is completed by a user connecting multiple graphics (for instance, nodes) associated with processing, the controller 22 notifies of the situation.

A description is given using a specific example. For instance, when a program part for executing an operation such as “baggage is carried by a robot as the device 12” is completed, the controller 22 shows the operation implemented by the program part using an image. A description is given using the example illustrated in FIG. 15. An image 172 shows a robot, and an image 174 shows a baggage. The images 172,174 show a manner in which a robot lifts a baggage. The images 172, 174 are displayed on the screen 76 of the terminal apparatus 10, and when a program part for implementing the above-mentioned operation is completed, the controller 22 moves the images 172, 174 in the direction indicated by an arrow 176 on the screen 76.

According to the seventh modification, when a program is partially completed, a user is notified of the situation. Also, it is possible to visually notify a user of completion of a program by representing a completed operation using an image.

When a program for controlling the device 12 is partially completed,

The controller 22 may represent an operation implemented by the program by an image associated with the device 12. For instance, when a program for controlling the robot 12A is partially completed, the controller 22 may represent an operation (for instance, an operation of carrying a baggage by the robot 12A) implemented by the program with an image associated with the robot 12A. Alternatively, the controller 22 may represent an operation implemented by the program by an image associated with a personal assistant mounted in the robot 12A. For instance, instead of the image 80 illustrated in FIG. 6, the controller 22 may display an image showing the appearance of a personal assistant on the screen 76, and may represent an operation implemented by the program with the image.

Also, when a function is added by a program, the controller 22 may represent the function using an image. For instance, when a new function is added to the device 12 by editing a program portion in the exemplary embodiment or the modifications described above, or when a new function is added to the device 12 by generating a program based on instructions of a user, the controller 22 may represent the function using an image.

The processing will be described in detail with reference to FIG. 16. FIG. 16 illustrates an example of an image associated with the device. For instance, it is assumed that a function of flying in the sky is added to the robot as the device 12 by a program. The controller 22 displays an image 178 representing the robot on the screen 76 before generation or during generation of the program as illustrated in FIG. 16A. When a function of flying in the sky is added to the robot by the program, the controller 22 displays an image 180 representing the robot having the added function instead of the image 178 on screen 76 as illustrated in FIG. 16B. Although a function of flying in the sky is not shown in the image 178 before addition of the function, wings are shown in the image 180 after the addition. In this manner, it is possible to visually notify a user of addition of a new function to the robot.

When messages are exchanged between a personal assistant mounted in the robot 12A and a user as in the exemplary embodiment described above, the controller 22 may display the image 178 as the image associated with the personal assistant on the screen 76. For instance, instead of the image 80 illustrated in FIG. 6, the controller 22 may display the image 178 on the image 76. In this case, when a function of flying in the sky is added to the robot 12A, instead of the image 178, the controller 22 may display the image 180 on the image 76.

(Eighth Modification)

An eighth modification will be described. In the eighth modification, when a program portion to which change of setting is to be made is not identifiable by the content of an utterance of a user, questions for obtaining information from a user for identifying the program portion to which change of setting is to be made are presented to the user.

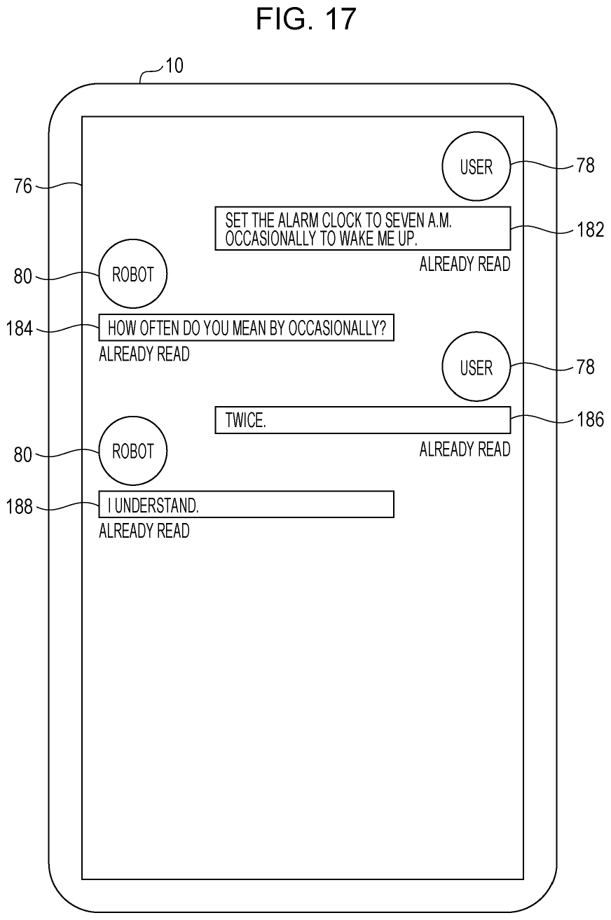

Hereinafter, the eighth modification will be described in detail with reference to FIG. 17. FIG. 17 illustrates an example of a screen. Here, it is assumed that the terminal apparatus 10 is connected to the robot 12A, and messages are exchanged between a personal assistant mounted in the robot 12A and a user.

When a user inputs the content of an utterance 182 with which a program portion to which change of setting is to be made is not identifiable for a personal assistant, the personal assistant repeats questions. For instance, the content of the utterance 182 includes an expression “occasionally”, and it is not possible for the personal assistant to identify the program portion with this expression. In this case, the personal assistant sends a message for asking a user the meaning of the ambiguous expression as the content of an utterance 184. A user answers the question as the content of an utterance 186, and when the program portion is identifiable by the content of the answer for the personal assistant, the content of an utterance 188 showing that the program portion has been identified is displayed on the screen 76. In this manner, the personal assistant repeats questions until the program portion is identified.

Also, the personal assistant may prepare a list of candidates for question to be answered by a user, and the controller 22 may display the list on the screen 76. As another example, the personal assistant may prepare a list of candidates for answer shown by links, and the controller 22 may display the list of candidates on the screen 76. As another example, the personal assistant may prepare candidates for answer based on the attributes (for instance, sex, occupation, age) of a user or the usage history of the device 12. For instance, the personal assistant obtains information indicating attributes of a user from images generated by photographing a user with a camera, voice collected by a microphone, and/or information stored in the terminal apparatus 10 associated with a user. Also, the personal assistant may obtain information indicating attributes of a user by utilizing biological information (for instance, brain waves, pulse waves, and fingerprints) of a user.

According to the eighth modification, even when the program portion is not identifiable by the content of an utterance of a user, questions for identifying the program portion are presented to the user, thus it is possible to identify the program portion.

(Ninth Modification)

A ninth modification will be described. In the ninth modification, the terminal apparatus 10 is notified of functions feasible using the device 12.

For instance, when a user sets a function to the device 12, the device 12 transmits information indicating the function to the terminal apparatuses 10 of other users, connected to the device 12. The controller 22 of each of the terminal apparatuses 10 of other users displays information indicating the function on the UI unit 16. For instance, when a user sets a function to the device 12 by setting a program to be executed in the device 12, and the terminal apparatuses 10 of other users are connected to the device 12, information indicating the function is displayed on the terminal apparatuses 10. In this manner, the terminal apparatuses 10 of other users connected to the device 12 are notified of a function set to the device 12 by a user. Alternatively, the terminal apparatuses 10 of users having other user accounts may be notified of a function set to the device 12 by a user having a user account.

For instance, when a user sets the function of “the procedure for leading a meeting” to the robot 12A by setting a program related to “the procedure for leading a meeting” to the robot 12A, the terminal apparatuses 10 of other users connected to the robot 12A are notified of the function.

When hardware or software is added to the device 12, the device 12 may transmit information to each terminal apparatus 10 connected to the device 12, the information indicating that the specification of the device 12 has been improved. In this case, the controller 22 of the terminal apparatus 10 displays the information on the UI unit 16. For instance, the device 12 transmits information to the terminal apparatus 10, the information indicating functions become feasible by addition of hardware or software, and the controller 22 displays the information indicating the function on the UI unit 16.

For instance, when the robot 12A acquires a flight function by having wings for implementing the flight function, the terminal apparatus 10 connected to the robot 12A is notified of the flight function.

Also, the controller 34 of the device 12 may manage the usage history of the functions (for instance, a function set by a program) set to the device 12 for each user. When the terminal apparatus 10 is connected to the device 12, the controller 34 obtains information, which identifies a user who utilizes the terminal apparatus 10, from the terminal apparatus 10, refers to the usage history of the user, and predicts the functions expected to be performed by instructions of the user, or the functions expected to be useful to the user. The device 12 transmits information to the terminal apparatus 10, the information indicating a result of the prediction. The controller 22 of the terminal apparatus 10 displays on the UI unit 16 the information indicating a result of the prediction.

According to the ninth modification, a user may be notified of functions feasible using the device 12.

(10th Modification)

A 10th modification will be described. In the 10th modification, when the content of a program portion in which change in accordance with a request for change of setting has been reflected is inconsistent with the content of another program portion which is already set, alert processing is performed.

Hereinafter, the 10th modification will be described in detail. For instance, a program portion is generated for executing a light on function, that is, “when opening of a door is detected by a sensor, a lighting device is turned on”, the program portion is stored in the lighting device as the device 12, and thus the light on function is set to the lighting device. In this case, a program portion is generated for executing a light off function, that is, “when opening of a door is detected by a sensor, a lighting device is turned off”, the program portion is stored in the same lighting device, and thus the light off function is set to the lighting device.

For instance, user A generates a program portion for executing a light on function using the terminal apparatus 10, stores the program portion in the lighting device, thereby setting the light on function to the lighting device. In this case, it is assumed that user A or another user B generates a program portion for executing the light off function using the terminal apparatus 10, and gives instructions for storing the program portion in the same lighting device.

The controller 34 of the lighting device compares the functions already set in the lighting device with a function newly set, and determine whether or not those functions are mutually inconsistent. When those functions are not mutually inconsistent, the controller 34 stores a program portion for executing a new function in the storage 28, and sets the new function to the lighting device itself. When those functions are mutually inconsistent, the controller 34 performs alert processing.

For instance, during execution of a function A in the device 12, if it is not possible to execute another function B, the functions A and B are mutually inconsistent. When a description is given using the example above, it is not possible to achieve both light on and light off by the same lighting device, thus the light on function and the light off function are mutually inconsistent.

It is to be noted that respective periods of time may set for the functions. In this case, even when mutually inconsistent functions A, B are set to the same device 12, if respective execution times of the functions A, B do not overlap with each other, the controller 34 recognizes that the functions A, B are not mutually consistent, and sets both the functions A, B to the device 12 without performing alert processing. When respective execution times of the functions A, B overlap with each other, the controller 34 performs alert processing.

Hereinafter, the alert processing will be described. As the alert processing, the controller 34 may overwrite a program portion already set (for instance, a program portion for executing the function A) with a new program portion (for instance, a program portion for executing the function B), and may store the new program portion in the device 12. Consequently, in the device 12, the function A is not executed, but the function B is executed.

As another alert processing, when a user who has the same account as the account of another user who has already set the function A to the device 12 gives instructions for setting the function B to the device 12, the controller 34 overwrites the program portion for executing the function A with the program portion for executing the function B, and stores the program portion in the device 12. In contrast, when a user who has the different account from the account of another user who has already set the function A to the device 12 gives instructions for setting the function B to the device 12, the controller 34 transmits information to the terminal apparatus 10 of a user who has set the function A, the information indicating that a function inconsistent with the function A is about to be set to the device 12. The controller 22 of the terminal apparatus 10 displays information indicating the situation on the UI unit 16. It is to be noted that the information indicating the situation may be outputted from the terminal apparatus 10 or the device 12. When a user who has set the function A gives instructions for overwriting the program portion using the terminal apparatus 10, the controller 34 of the device 12 overwrites the program portion for executing the function A with the program portion for executing the function B, and stores the program portion in the device 12.

As still another alert processing, when a program portion already set is overwritten with a new program portion, the controller 34 of the device 12 may transmit information to the terminal apparatus 10 of another user who has set a program portion to the device 12, the information indicating that the program portion has been overwritten. The controller 22 of the terminal apparatus 10 displays the information indicating the overwriting situation on the UI unit 16. The information indicating the overwriting situation may be transmitted to the terminal apparatus 10 via an E-mail. Also, when another users logs in the device 12 using the terminal apparatus 10, the controller 34 may transmit information indicating the log-in situation to the terminal apparatus 10.

Hereinafter, the 10th modification will be described by giving a specific example. For instance, it is assumed that user A generates a program portion for executing a light on function using its own terminal apparatus 10A, stores the program portion in a lighting device as the device 12, and thereby sets the light on function to the lighting device. Like this, when the light on function is already set to the lighting device, it is assumed that user B generates a program portion for executing a light off function using its own terminal apparatus 10B, and gives instructions for setting a light off function to the lighting device. The light on function and the light off function are mutually inconsistent functions, thus the controller 34 of the lighting device performs the alert processing. Consequently, a program portion having the light on function is overwritten with a program portion having the light off function, thus the light off function may be set to the lighting device, or alert information may be transmitted from the lighting device to the terminal apparatus 10A.

The alert processing may be executed when instructions are given by the same user or users having the same account for setting a program portion for executing a function inconsistent with a function already set to the device 12.

Also, when instructions are given by a user for setting a program portion for executing a function to the terminal apparatus 10, the function being inconsistent with a function which has been set to the terminal apparatus 10, the controller 22 of the terminal apparatus 10 may execute the alert processing.

According to the 10th modification, when instructions are given for setting a program portion which is inconsistent to a program portion already set, it is possible to resolve the contradiction.

Although in the exemplary embodiment and modifications described above, the changer 32 of the device 12 changes a program portion stored in the device 12, the changer 20 of the terminal apparatus 10 operated by a user may change a program portion stored in the device 12.

As an example, the terminal apparatus 10 and the device 12 are implemented by cooperation between hardware and software. Specifically, the terminal apparatus 10 and the device 12 include one or multiple processors such as CPUs which are not illustrated. The function of each component of the terminal apparatus 10 and the device 12 is implemented by the one or multiple processors reading and executing a program stored in a storage device which is not illustrated. The program is stored in a storage device through a recording medium such as a CD or a DVD or through a communication path such as a network. As another example, each component of the terminal apparatus 10 and the device 12 may be implemented by hardware resources such as a processor, an electronic circuit, and an application specific integrated circuit (ASIC), for instance. A device such as a memory may be utilized for the implementation. As still another example, each component of the terminal apparatus 10 and the device 12 may be implemented by a digital signal processor (DSP) or a field programmable gate array (FPGA).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a control unit that, when a request for change of setting is made by a user through a conversational user interface, controls notification of setting information of a program portion to which the change of setting is to be made; and
a change unit that changes the program portion in accordance with the request for the change of setting.

2. An information processing device comprising
a control unit that, when a request for change of setting is made by a user through a conversational user interface, controls display of a graphic representing a program portion to which the change of setting is to be made, the display being notification of setting information of the program portion.

3. The information processing device according to claim 1,
wherein the program portion provides a program for controlling a device, and the device operates according to whether or not the change of setting is possible.

4. The information processing device according to claim 1,
wherein the program portion provides a program for controlling a device, and the control unit further controls display of an image which represents a chatbot associated with the device in the user interface.

5. The information processing device according to claim 4,
wherein when a request for the change of setting is made in exchange of messages between the chatbot and the user in the user interface, the control unit controls notification of setting information of the program portion to which the change of setting is to be made.

6. The information processing device according to claim 4,
wherein when part of the program in an operable unit is completed, the control unit further controls notification of the completion.

7. The information processing device according to claim 6,
wherein the control unit further represents an operation implemented by the part of the program, using an image.

8. The information processing device according to claim 4,
wherein when a function is added by the program, the control unit further represents the function using an image.

9. The information processing device according to claim 3,
wherein when it is not possible for the device to perform a content of the change of setting, the control unit further controls notification of the no possibility.

10. The information processing device according to claim 3,
wherein the control unit further controls notification of a function which is capable of being performed using the device.

11. The information processing device according to claim 1,
wherein the control unit further controls notification of setting information of the program portion in which change in accordance with the request for change of setting has been reflected.

12. The information processing device according to claim 1,
wherein the control unit further controls notification of candidates of processing corresponding to a content of the change of setting.

13. The information processing device according to claim 1,
wherein the control unit further controls notification of candidates for the program portion in which change in accordance with the request for change of setting has been reflected.

14. The information processing device according to claim 1,
wherein after the change in accordance with the request for change of setting reflects in the program portion, the control unit further compiles the program portion in which the change has been reflected.

15. The information processing device according to claim 1,
wherein a content of the change of setting is a character string describing processing, and provided by a character string written using a programming language.

16. The information processing device according to claim 1,
wherein a content of the change of setting is provided by a graphic associated with processing.

17. The information processing device according to claim 16,
wherein the control unit further controls display of candidates for the graphic.

18. The information processing device according to claim 1,
wherein in accordance with a transmission command of the program portion, the control unit further controls transmission of the program portion to an account different from an account which has issued the transmission command.

19. The information processing device according to claim 1,
wherein the change includes at least one of addition of processing to the program portion and deletion of processing from the program portion.

20. The information processing device according to claim 1,
wherein when a program portion to which the change of setting is to be made is not identifiable, the control unit further controls notification of a question to for obtaining information from a user for identifying the program portion to which the change of setting is to be made.

21. The information processing device according to claim 1,
wherein when a content of the program portion in which change in accordance with the request for change of setting has been reflected is inconsistent with a content of another program portion which is already set, the control unit further controls execution of alert processing.

22. A non-transitory computer readable medium storing a program causing a computer to execute a process, the process comprising:
when a request for change of setting is made by a user through a conversational user interface, controlling notification of setting information of a program portion to which the change of setting is to be made; and
changing the program portion in accordance with the request for the change of setting.

23. A non-transitory computer readable medium storing a program causing a computer to execute a process, the process comprising, when a request for change of setting is made by a user through a conversational user interface,
controlling display of a graphic representing the program portion to which the change of setting is to be made, the display being notification of setting information of the program portion.
